(19) United States
(12) Patent Application Publication
(10) Pub. No.: US 2010/0041484 A1
(43) Pub. Date: Feb. 18, 2010

(54) COUPLING FOR A MOVABLE PART OF A PIECE OF FURNITURE

(76) Inventor: Simon GASSNER, Dornbirn (AT)

Correspondence Address: WENDEROTH, LIND & PONACK, L.L.P., 1030 15th Street, N.W.,, Suite 400 East, Washington, DC, 20005-1503, US

(21) Appl. No.: 12/582,217

(22) Filed: Oct. 20, 2009

Related U.S. Application Data
(63) Continuation of application No. PCT/AT2008/000064, filed on Feb. 27, 2009.

(30) Foreign Application Priority Data
Apr. 23, 2007 (AT) A 628/2007

(51) Int. Cl. F16D 3/00

(52) U.S. Cl. 464/106

(57) ABSTRACT

The invention relates to a coupling for detachably connecting a mobile part of a piece of furniture to a drive. Said coupling comprises a coupling element that can be moved between the mobile part of the piece of furniture and the drive in a limited manner in at least one direction, in order to compensate position tolerances in relation to the at least one direction.

The present invention concerns a coupling for releasably connecting a movable furniture part to a drive, wherein the coupling has a coupling portion.

Couplings of that kind suffer from the problem that, due to positional tolerances of the movable furniture part relative to the drive, it may be difficult to make the connection between the movable furniture part and the drive. The positional tolerances may involve for example installation tolerances. They are to be attributed to the fact that neither the drive nor the movable furniture part is mounted exactly at the same location on a body or carcass of an article of furniture, in each mounting operation.

A further example of positional tolerances are operating tolerances which are therefore not to be attributed to inaccurate fitment of the drive or the furniture part in the furniture body or carcass, but which inevitably occur in operation of the movable furniture part. It is known for example that a movable furniture part which is in the form of a drawer can rise or fall by some millimeters, depending on the respective loading condition.

The object of the invention is to provide a coupling of the general kind set forth, which is suitable for overcoming the above-discussed problems.

According to the invention that is attained by a coupling having the features of claim 1.

The provision of a limited mobility of the coupling portion in the direction to be compensated means that positional tolerances are of no consequence either in the form of installation tolerances or in the form of operating tolerances.

The concept according to the invention is admittedly not limited to a given kind of drive. A particularly preferred embodiment however is one in which it is provided that the drive has a pulling means which can be wound onto a roller drivable by an electric motor. In that case the limited mobility of the coupling portion at least along the line of action of the drive (that is to say in or in opposite relationship to the extension direction of the movable furniture part) can be implemented by the pulling means or the roller having a certain play. In other words, even when the drive is not activated, the pulling means because of the play can be unwound from or wound onto the roller.

With this embodiment it can further be provided that the drive has a housing, wherein provided in the unwinding region of the roller is a window for the exit of the pulling means and the window is substantially larger than the diameter of the pulling means. That also affords a compensation option for directions which extend in orthogonal relationship to the line of action of the drive. For example the pulling means will generally be of a diameter of between 0.5 mm and 1 mm. In that case it is sufficient if the window is of a dimension in the region of about 5 mm (for example in the case of a square configuration, for each side).

A further advantageous embodiment is afforded if it is provided that the coupling portion is a magnet connected to the pulling means. Movable furniture parts normally have a metallic rear wall (for example a metallic drawer body frame). In that case the magnet can couple at any position delimited only by the pulling means anywhere on the rear side of the movable furniture part.

In another embodiment of the invention it is provided that the coupling portion has a first part for mounting to the movable furniture part and a second part for mounting to the drive.

In that case it can be provided that the second part is mounted on a slide displaceable in two mutually orthogonal directions which extend in orthogonal relationship with the line of action of the drive. That affords a compensating option in relation to positional tolerances in orthogonal relationship with the line of action of the drive.

Alternatively or additionally it can be provided that the second part is mounted limitedly movably along the line of action of the drive, thereby affording a compensating option along the line of action of the drive.

Further alternatively or additionally it can be provided that the second part is mounted pivotably relative to a housing of the drive. A pivotable mounting arrangement also affords compensating options both in the line of action of the drive and also in orthogonal relationship with that line of action.

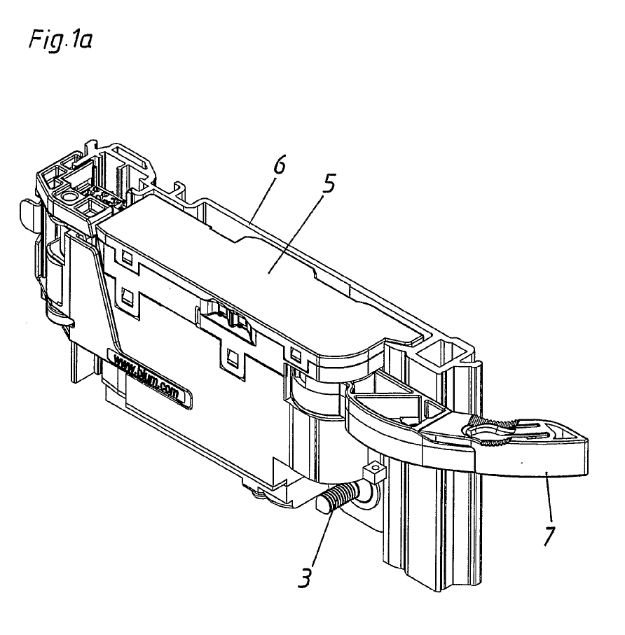

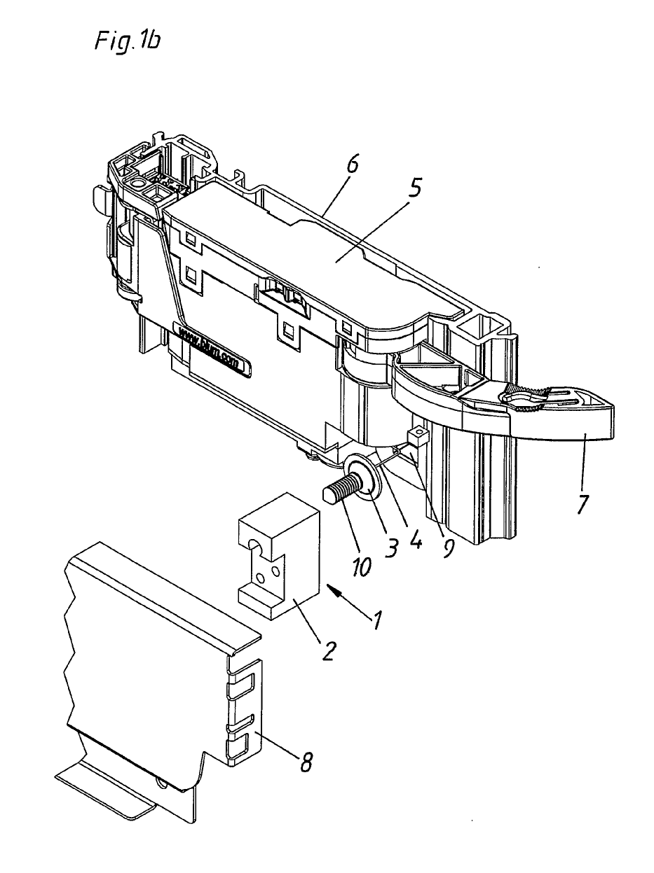

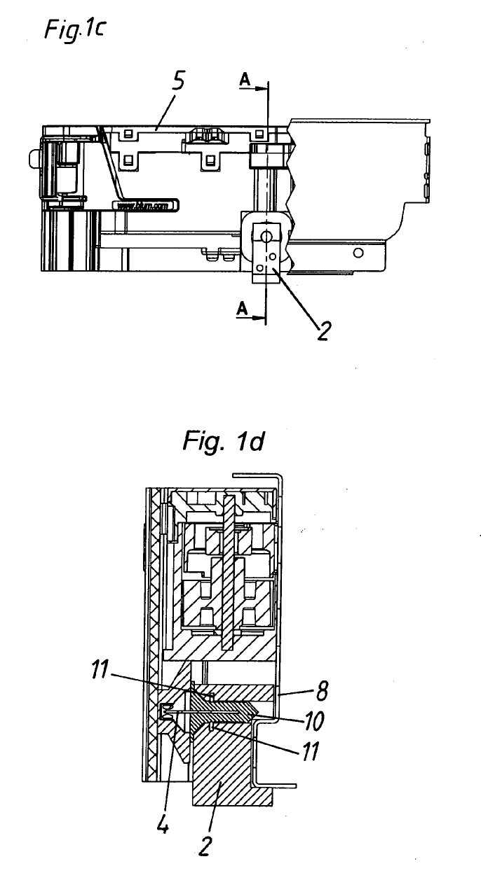

Further advantages and details of the invention will be apparent from the Figures and the related specific description. Therein FIGS. 1 through 5 each show an embodiment of the invention as a perspective view, a partial exploded view and a sectional view.

Each of the Figures shows a drive 5 which is releasably fixed to a profiled rail 6 and has an ejection lever 7 and a pull-in retraction device having a pulling means 4. The embodiments differ in the configuration of the coupling 1.

Thus FIGS. 1a through 1c show an embodiment of the coupling 1, having two parts 2, 3, wherein the first part 2 is provided for mounting to the movable furniture part 8 and the second part 3 is provided for mounting to the drive 5.

The pulling means 4 is passed out of the housing of the drive 5 by way of deflection rollers (not shown in FIG. 1b but see FIG. 1c) and a window 9. That affords a compensating option in respect of positional tolerances in directions which extend in orthogonal relationship with the line of action of the drive (in all the Figures, the direction of movement of the pulling means 4 outside the housing). To compensate for positional tolerances in the line of action of the drive 5 the second part 3 has a grooved pin 10, the first part 2 being of such a configuration that the pin 10 can be locked with each individual groove in the first part 2, more specifically by way of clamping jaws 11 (see the sectional view in FIG. 1c).

In all embodiments the movable furniture part 8 is in the form of a drawer.

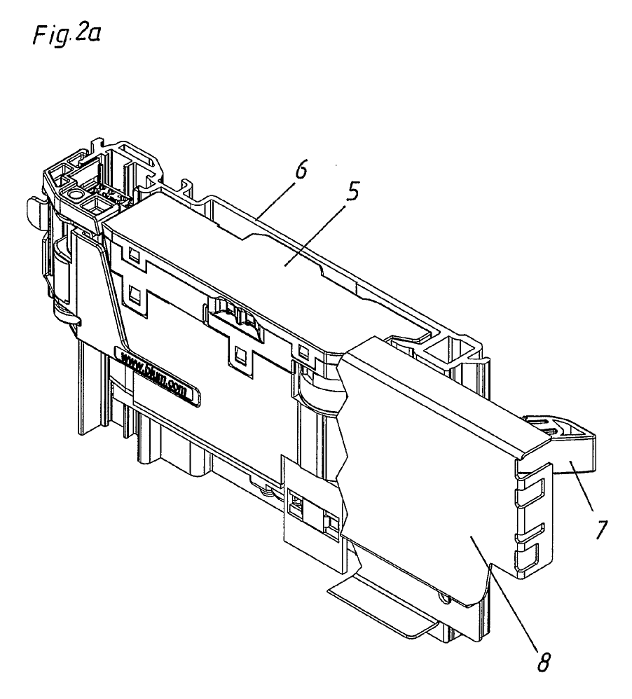

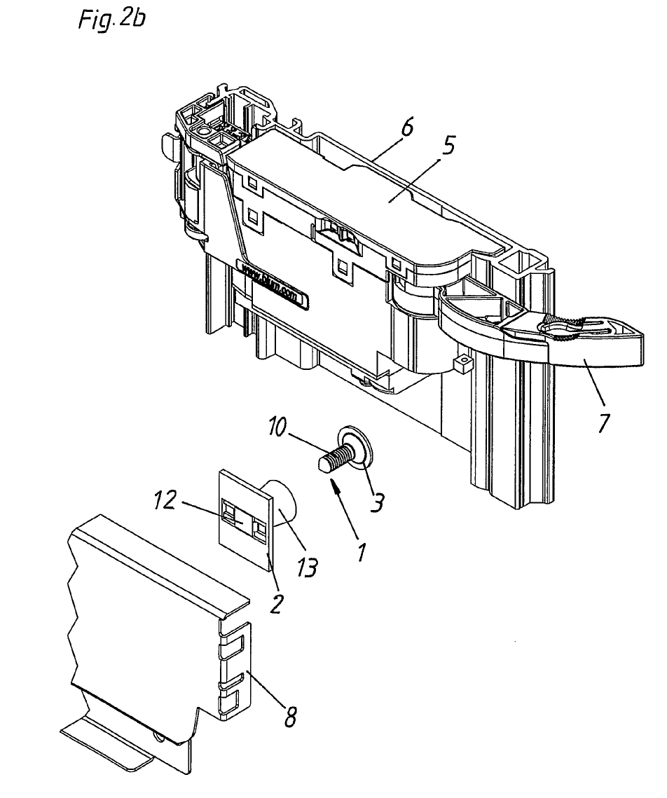

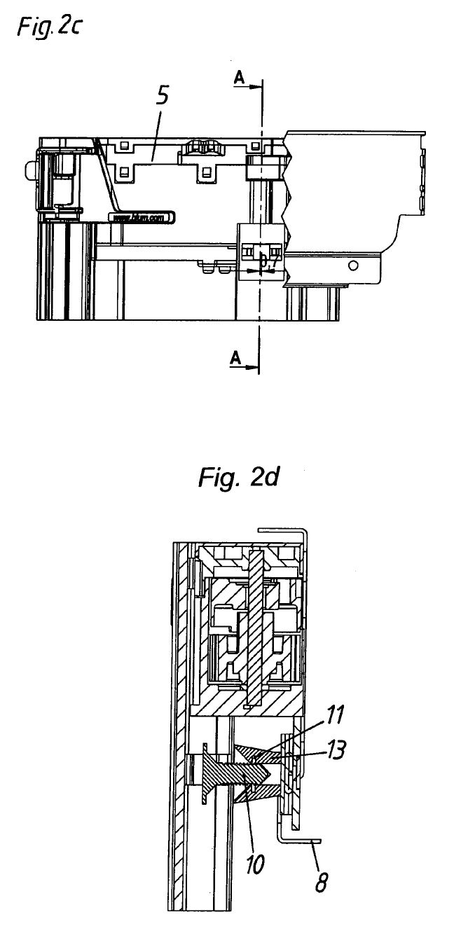

The coupling 1 is also of a two-part structure in the embodiment of FIGS. 2a through 2c. In this case once again the second part 3 has a grooved pin 10 which can provide for compensation in the line of action of the drive 5.

To provide for compensation in respect of positional tolerances in a direction orthogonal to the line of action of the drive 5 the first coupling portion 2 has a capture part 13 which is mounted on a slide 12 and which is of a funnel-shaped configuration.

In this case the slide 12 is mounted limitedly displaceable along two orthogonal directions.

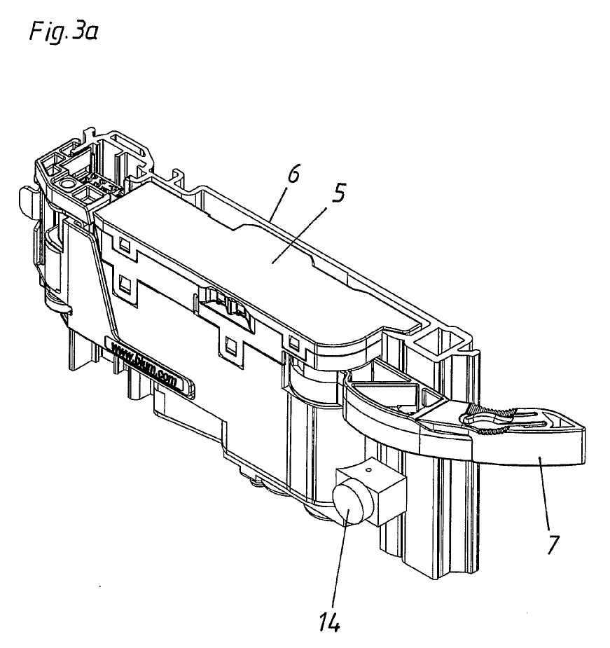

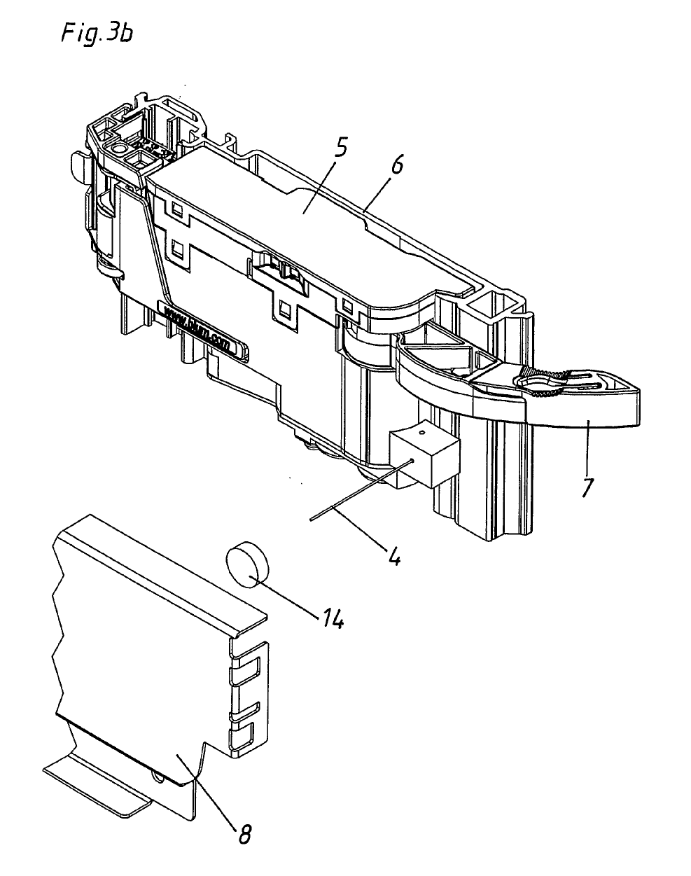

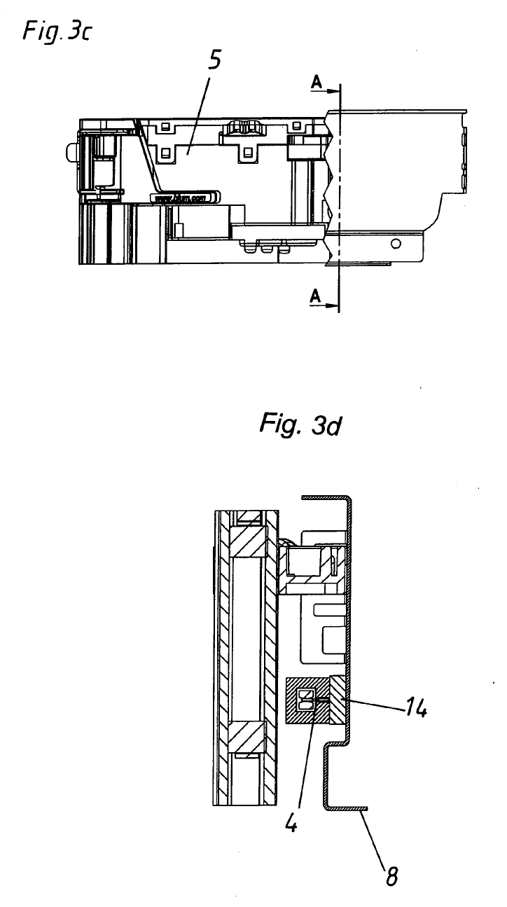

In the embodiment of FIGS. 3a through 3c the coupling 1 is of a one-part nature and has a coupling portion in the form of a magnet 14. In this case the magnet 14 is connected to the free end of the pulling means 4. The mobility of the pulling means 4 and the fact that in principle the magnet 14 can cling to any location on the metallic furniture part 8 provide a compensating option for positional tolerances both in the line of action of the drive 5 and orthogonally thereto.

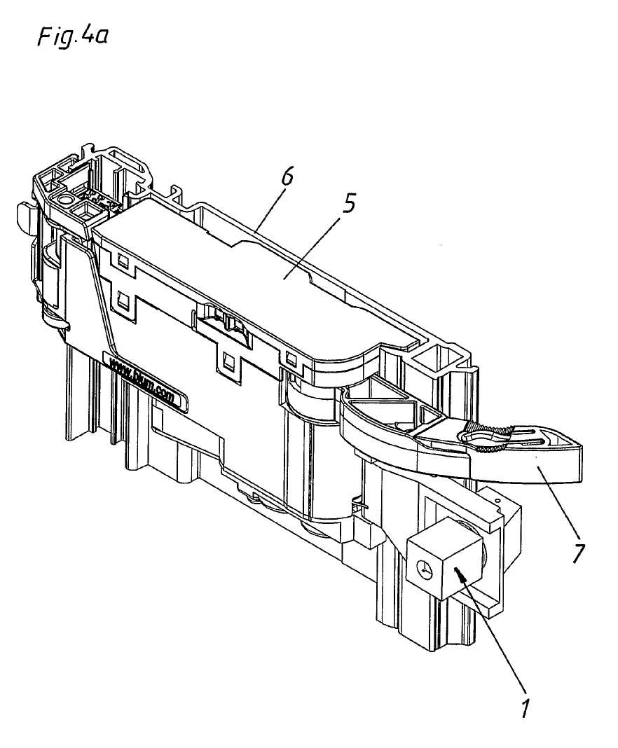

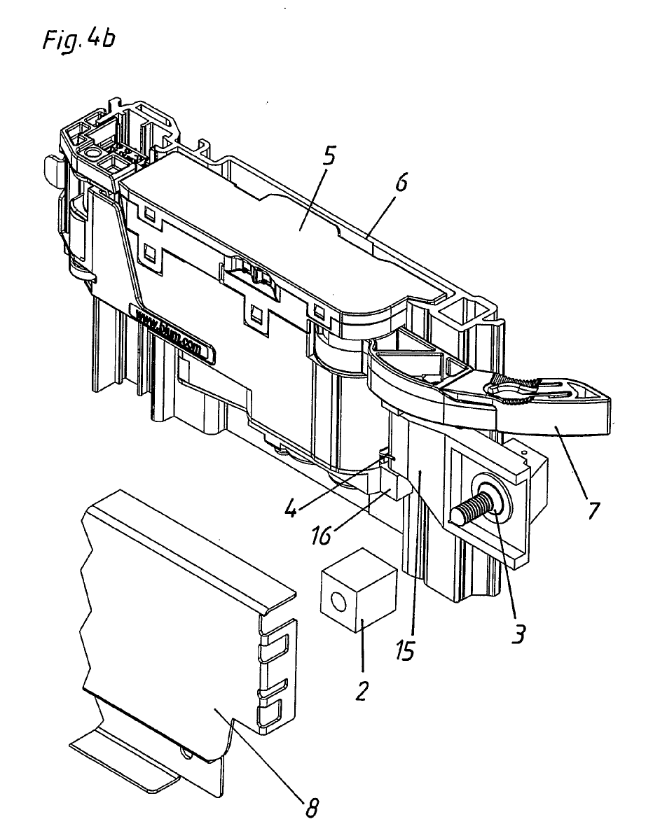

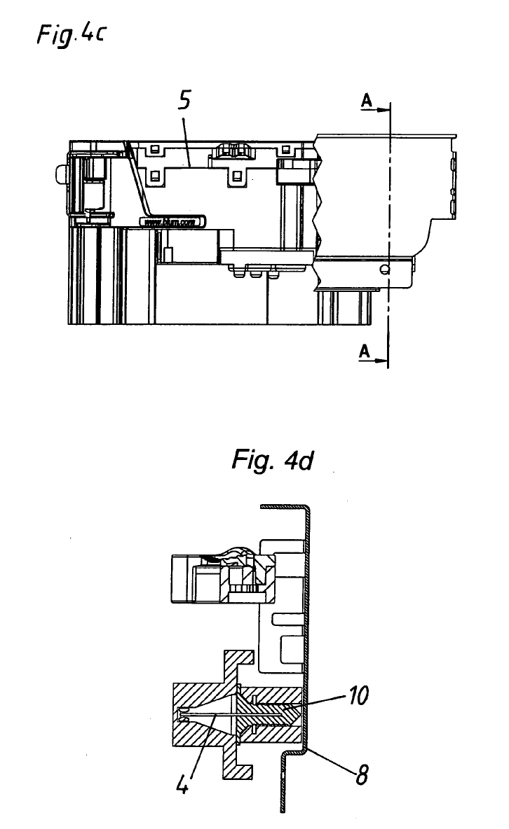

The embodiment of FIGS. 4a through 4c again has a two-part coupling 1. This corresponds to the coupling 1 shown in FIGS. 1a through 1c, with the differences that the second coupling portion 3 is mounted pivotably relative to the housing of the drive 5 (the part 15 is mounted pivotably by way of the joint 16 to the housing of the drive 5). The pulling means 4 is passed out of the housing of the drive 5 in the rear-wall region of the portion 15 and connected with the free end to the second part 3 of the coupling 1.

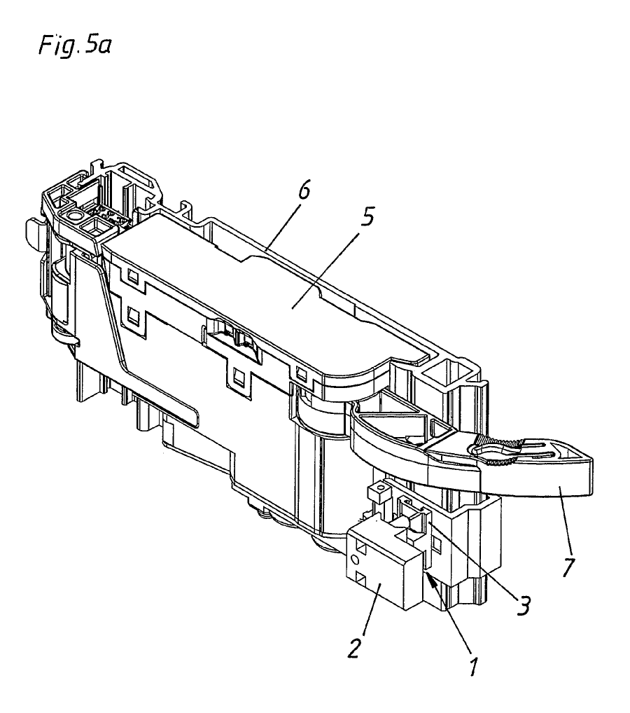

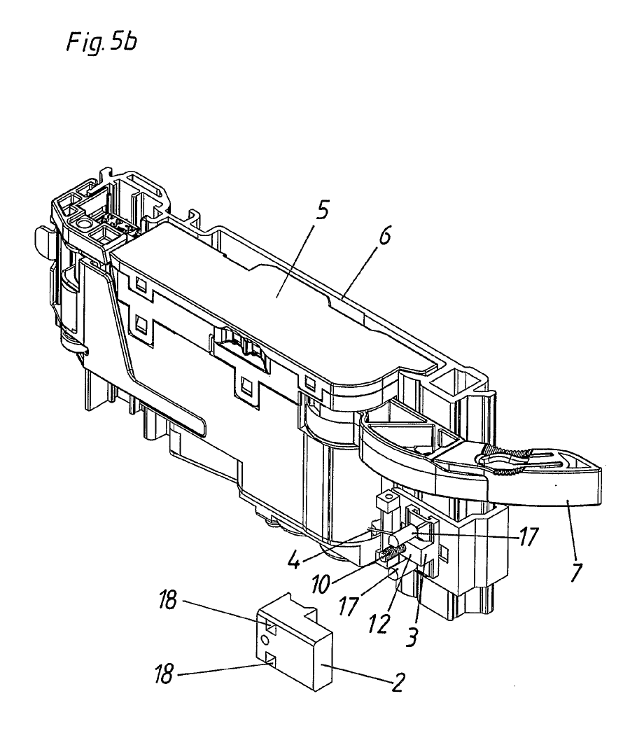

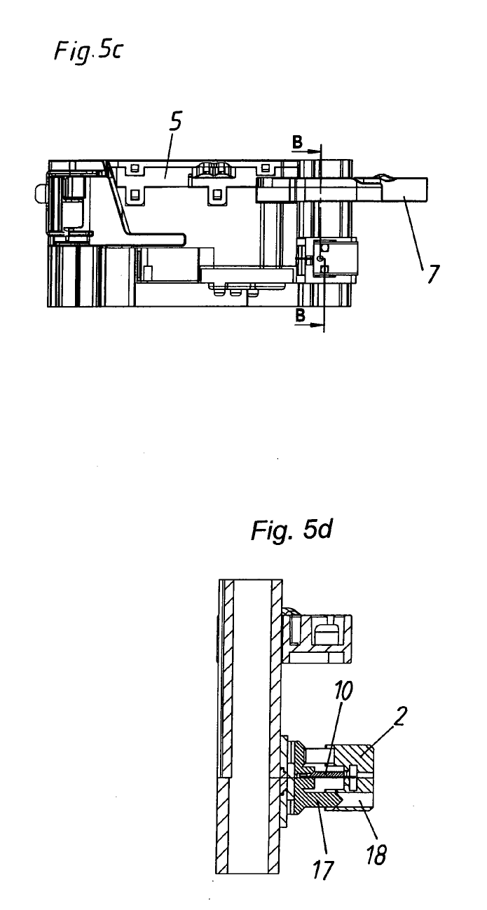

In the embodiment of FIGS. 5a through 5c the second part 3 of the coupling 1 is mounted on a slide 12 (corresponding to FIG. 2a). The second part 3 again has a grooved pin 10. The slide 12 is mounted limitedly movably along two mutually orthogonal directions. Provided for centering the pin 10, there are two centering pins 17 engaging into corresponding openings 18 on the first part 2 of the coupling 1. The first part 2 is again arranged at the rear wall of a movable furniture part 8 (not shown in FIGS. 5a through 5c).

1. A coupling for releasably connecting a movable furniture part to a drive, wherein the coupling has a coupling portion, wherein to compensate for positional tolerances in relation to at least one direction the coupling portion is limitedly movable in the at least one direction between the movable furniture part and the drive.

2. A coupling as set forth in claim 1 wherein the drive has a pulling means which can be wound onto a roller drivable by an electric motor.

3. A coupling as set forth in claim 2 wherein the drive has a housing, wherein provided in the unwinding region of the roller is a window for the exit of the pulling means and the window is substantially larger than the diameter of the pulling means.

4. A coupling as set forth in claim 3 wherein the coupling portion is a magnet connected to the pulling means.

5. A coupling as set forth in claim 1 wherein the coupling portion has a first part for mounting to the movable furniture part and a second part for mounting to the drive.

6. A coupling as set forth in claim 5 wherein the second part is mounted on a slide displaceable in two mutually orthogonal directions which extend in orthogonal relationship with the line of action of the drive.

7. A coupling as set forth in claim 5 wherein the second part is mounted limitedly movably along the line of action of the drive.

8. A coupling as set forth in claim 5 wherein the second part is mounted pivotably relative to a housing of the drive.

9. A coupling 1 as set forth in claim 1 wherein the action of the drive is effected along a notional line of action, wherein the coupling portion is limitedly movable for compensation of positional tolerances in a direction orthogonal to the line of action of the drive.
